(19) United States
(12) Patent Application Publication
(10) Pub. No.: US 2021/0364872 A1
(43) Pub. Date: Nov. 25, 2021

(54) OPTICAL STRUCTURE, DISPLAY DEVICE AND METHOD FOR MANUFACTURING OPTICAL STRUCTURE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventor: Quan GAN, Beijing (CN)

(73) Assignees: HEFEI XINSHENG OPTOELECTRONICS TECHNOLOGY CO., LTD., Hefei, Anhui (CN); BOE TECHNOLOGY GROUP CO., LTD., Beijing (CN)

(21) Appl. No.: 16/341,328

(22) PCT Filed: Aug. 27, 2018
(86) PCT No.: PCT/CN2018/102512

§ 371 Date: Apr. 11, 2019

(30) Foreign Application Priority Data
Feb. 5, 2018 (CN) 201810111869.1

(51) Int. Cl. G02F 1/1362

(52) U.S. Cl. CPC G02F 1/136222

(57) ABSTRACT

An optical structure, a display device and a method for manufacturing an optical structure and are provided. The optical structure includes a first positioning plate, a second positioning plate and a liquid crystal layer. The first positioning plate and the second positioning plate are oppositely disposed, and the liquid crystal layer is arranged between the first positioning plate and the second positioning plate. A surface of the first positioning plate close to the liquid crystal layer is provided with a plurality of protruding structures protruding toward the liquid crystal layer.

### CROSS-REFERENCE TO RELATED APPLICATION

The present application claims a priority of the Chinese patent application No. 201810111869.1 filed on Feb. 5, 2018, which is incorporated herein by reference in its entirety.

### TECHNICAL FIELD

The present disclosure relates to the field of display technology, in particular to an optical structure, a display device and method for manufacturing the optical structure.

### BACKGROUND

Since light incident into a liquid crystal display are refracted and reflected in a liquid crystal layer of the liquid crystal display and the output light may have certain directivity, which result in color distortion when viewed from a direction beyond a range of visual angle, so that the visual angle of the liquid crystal display determines a visible range and a best viewing angle.

The requirement for testing the visual angle in the display industry is to take a ratio of a brightness of a display panel in an all-white (L255) state to a brightness of a display panel in an all-black (LO) state as the visual angle, and the visual angle can also be expressed by the Contrast Ratio (CR). Generally, ordinary users can take a visual angle of 120 degrees as a selection criterion. However, with the development of display technology and increasement of customer's requirements for display quality, requirements for the visual angle of display products are also constantly increasing. For example, users require a high display quality of a vehicle display product or a public display product. The display modes of in-plane switching (IPS), advanced super dimension switch (ADS), and high advanced super dimension switch (HADS) in the related art can hardly achieve user requirements for visual angles. Display products with large visual angle may have low Contrast Ratio (CR), leading to a poor user experience.

### SUMMARY

An optical structure includes a first positioning plate, a second positioning plate and a liquid crystal layer;

where the first positioning plate and the second positioning plate are oppositely disposed;

the liquid crystal layer is arranged between the first positioning plate and the second positioning plate; and

a surface of the first positioning plate close to the liquid crystal layer is provided with a plurality of protruding structures protruding toward the liquid crystal layer.

In some embodiments, a surface of the second positioning plate close to the liquid crystal layer is provided with a plurality of recessed structures recessed away from the liquid crystal layer.

In some embodiments, the liquid crystal layer has a same thickness at any position between the first positioning plate and the second positioning plate.

In some embodiments, the number of the plurality of recessed structures is the same as the number of the plurality of protruding structures, and each recessed structure is arranged oppositely to one protruding structure, a shape of the recessed structure matches with a shape of the protruding structure, and a size of the recessed structure matches with a size of the protruding structure.

In some embodiments, the plurality of recessed structures and the plurality of protruding structures have arc curved surfaces.

In some embodiments, the plurality of protruding structures is sequentially connected on the surface of the first positioning plate close to the liquid crystal layer.

In some embodiments, the first positioning plate and the second positioning plate are made of a transparent material.

A display device includes the optical structure according to any one of above embodiments.

In some embodiments, display device further includes an array substrate and an opposite substrate, and the optical structure is disposed between the array substrate and the opposite substrate.

In some embodiments, the array substrate includes a plurality of pixel units; a projection of each of the plurality of pixel units on the array substrate is located in an orthographic projection of one of the plurality of protruding structures corresponding to the pixel unit on a plane of the array substrate; the number of the plurality of pixel units on the array substrate is the same as the number of the plurality of protruding structures; and different pixel units of the plurality of pixel units are located in different orthographic projections of different protruding structures of the plurality of protruding structures on the plane of the array substrate.

In some embodiments, the first positioning plate is disposed on the array substrate, and the second positioning plate is disposed the opposite substrate; or

the first positioning plate is disposed on the opposite substrate, and the second positioning plate is disposed the array substrate.

A method for manufacturing an optical structure includes:

forming a first positioning plate on a surface of which a plurality of protruding structures is provided;

providing a second positioning plate and oppositely arranging the first positioning plate and the second positioning plate to form a cell, wherein the surface of the first positioning plate provided with the plurality of protruding structures faces the second positioning plate; and

filling a space between the first positioning plate and the second positioning plate with liquid crystal to form a liquid crystal layer.

In some embodiments, the step of providing the second positioning plate includes

forming the second positioning plate on a surface of which a plurality of recessed structures is provided; and the surface of the second positioning plate provided with the plurality of recessed structures faces the first positioning plate.

In some embodiments, the step of forming the first positioning plate on a surface of which a plurality of protruding structures is provided includes:

providing a color film substrate; coating a transparent material layer on the color film substrate; and forming the plurality of protruding structures on the transparent material layer through a patterning process to form the first positioning plate; or,

providing an array substrate; coating a transparent material layer on the array substrate; and forming the plurality of protruding structures on the transparent material layer through a patterning process to form the first positioning plate.

In some embodiments, the step of forming the second positioning plate on a surface of which a plurality of recessed structures is provided includes:

providing a color film substrate; coating a transparent material layer on the color film substrate; and forming the plurality of recessed structures on the transparent material layer through a patterning process to form the second positioning plate; or,

providing an array substrate; coating a transparent material layer on the array substrate; and forming the plurality of recessed structures on the transparent material layer through a patterning process to form the second positioning plate.

### BRIEF DESCRIPTION OF THE DRAWINGS

FIG. 1 is a sectional view showing an optical structure according to some embodiments;

FIG. 2A is a sectional view showing an optical structure according to some embodiments;

FIG. 2B is a solid view showing an protruding structure according to some embodiments;

FIG. 3 is a sectional view showing an optical structure according to some embodiments;

FIG. 4 is a sectional view showing a display device according to some embodiments;

FIG. 5 is a sectional view showing a display device according to some embodiments; and

FIG. 6 is a flow chart showing a method for manufacturing an optical structure according to some embodiments.

### DETAILED DESCRIPTION OF THE EMBODIMENTS

Some embodiments provide an optical structure. For different side view angles, a thickness d of a path through which an incident light penetrates a liquid crystal layer varies greatly, and with larger value of d, the scattering index of liquid crystal (LC) cell (Scell) is increased while CR is reduced. In view of above principle, a surface of a first positioning plate for forming the liquid crystal layer is provided with a plurality of protruding structures protruding toward the liquid crystal layer, so that the liquid crystal molecules in the liquid crystal layer are arranged along with the plurality of protruding structures. Compared with optical structures having a same distance between substrates for forming a cell in the related art, the thickness of the liquid crystal layer of an optical structure in the following embodiments is reduced, and CR of the optical structure is increased, thereby solving the problem of a lowered CR for large viewing angle which cannot meet the user's visual requirements.

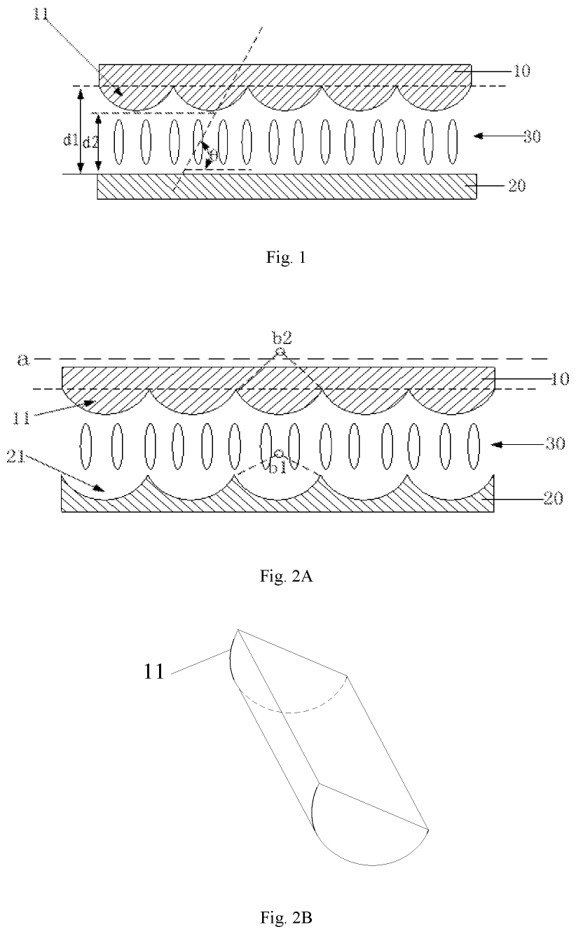

As shown in FIG. 1, some embodiments provide an optical structure including a first positioning plate 10, a second positioning plate 20, and a liquid crystal layer 30.

The first positioning plate 10 and the second positioning plate 20 are oppositely disposed, and the liquid crystal layer 30 is arranged between the first positioning plate 10 and the second positioning plate 20.

A surface of the first positioning plate 10 close to the liquid crystal layer 30 is provided with a plurality of protruding structures 11 protruding toward the liquid crystal layer 30.

Referring to FIG. 1, in some embodiments, a surface of the second positioning plate 20 close to the liquid crystal layer 30 is a plane. In this configuration, by providing the surface of the first positioning plate 10 close to the liquid crystal layer 30 with the plurality of protruding structures 11, a thickness of a path through which an incident light penetrates the liquid crystal layer is reduced from d1 to d2 on the condition that the lateral viewing angle is 0. Since a thickness of the liquid crystal layer is inversely proportional to a CR, the CR increases as the thickness of the liquid crystal layer decreases. In the related art, two opposite surfaces of the liquid crystal layer are planes, and the thickness of a path through which an incident light penetrates the liquid crystal layer is a constant value. A display device adopting the optical structure in the above embodiments will have a higher CR as compared with that in the related art, thereby solving a problem of a lowered CR for large viewing angle which cannot meet the user's visual requirements.

In some embodiments, according to characteristics of liquid crystal molecules, a relationship between a refractive index of the liquid crystal molecules and S_{lc} is as follows:

$${S}_{lc} = \frac{{\{ Δ n \times ( {n}_{e} + {n}_{0} ) \}}^{2}}{k}$$

$${S}_{cell} = \frac{{\{ Δ n \times ( {n}_{e} + {n}_{0} ) \}}^{2}}{k} \times d$$

$$wherein k = \frac{k 11 + k 22 + k 33}{3} , and Δ n = {n}_{e} - {n}_{0} .$$

K11, k22 and k33 refer to liquid crystal splay elastic coefficient, liquid crystal twist elastic coefficient and liquid crystal bending elastic coefficient respectively, S_{lc} is a scattering index of a liquid crystal (LC), and S_{cell} is a scattering index of LC cell. Δn is a birefringence of liquid crystal molecules, nₑ is a refractive index of an extraordinary ray, and n₀ is a refractive index of an ordinary ray.

According to the above formula, it can be determined that:

$$C R ∝ \frac{1}{{S}_{cell}} .$$

Therefore, in conjunction with FIG. 1, the thickness of a path through which the incident light penetrates the liquid crystal layer is reduced from d1 to d2 as compared with the related art, and therefore, S_{ca} decreases while the CR increases. For a same distance between the first positioning plate 10 and the second positioning plate 20, the optical structure in the above embodiments has a reduced thickness of the liquid crystal layer and an increased CR, thereby solving the problem of a lowered CR for large viewing angle which cannot meet the user's visual requirements.

Some embodiments provide an optical structure including a first positioning plate 10, a second positioning plate 20, and a liquid crystal layer 30, as shown in FIG. 2A.

The first positioning plate 10 and the second positioning plate 20 are oppositely disposed, and the liquid crystal layer 30 is arranged between the first positioning plate 10 and the second positioning plate 20.

As shown in FIG. 2A, the surface of the first positioning plate 10 close to the liquid crystal layer 30 is provided with a plurality of protruding structures 11 protruding toward the liquid crystal layer 30, and a surface of the second positioning plate 20 close to the liquid crystal layer 30 is provided with a plurality of recessed structures 21 recessed away from the liquid crystal layer 30.

By providing the plurality of recessed structure 21 on the second positioning plate 20, the light transmission effect of the liquid crystal layer 30 is ensured.

In some embodiments, as shown in FIG. 2A, the liquid crystal layer 30 has a same thickness at different positions.

In a display panel including the above optical structure, a thickness of the liquid crystal layer 30 is a length of a path through which an incident light perpendicular to a base substrate of the display panel penetrates liquid crystal molecules in the liquid crystal layer 30, in which the incident light are incident to the liquid crystal layer 30.

In some embodiments, referring to FIG. 2A, the number of the plurality of protruding structures 11 on the first positioning plate 10 is the same as the number of the plurality of recessed structures 21 on the second positioning plate 20, each recessed structure 21 is arranged oppositely to one protruding structure 11, a shape of the recessed structure 21 matches with a shape of the protruding structure 11, and a size of the recessed structure 21 matches with a size of the protruding structure 11.

In a display panel including the optical structure, a projection of a recessed structure 21 and a projection of a protruding structure 11 disposed opposite to the recessed structure 21 on a plane (e.g., plane a in FIG. 2A) parallel to a base substrate of a display panel are completely overlapped. The recessed structure 21 and the protruding structure 11 disposed opposite to the recessed structure 21 form a one-to-one corresponding structure. If cross sections of a protruding structure 11 and an oppositely disposed recessed structure 21 on any plane perpendicular to the base substrate have the same shape and size, it can be determined that the recessed structure 21 matches with the protruding structure 11 in shape and size.

In some embodiments, as shown in FIG. 2A, the recessed structures 21 and the protruding structures 11 both have arc curved surfaces. In a display panel assembled with the optical structure, a shape of a recessed structure 21 in any one of sectional views (e.g., a section shown in FIG. 2A) of the optical structure is an arc curve, and a shape of a protruding structure 11 in any one of sectional views (e.g., a section shown in FIG. 2A) of the optical structure is an arc curve. A curvature of a curve corresponding to the shape of the recessed structure 21 in any one of sectional views of the optical structure is the same as a curvature of a curve corresponding to the shape of the protruding structure 11 in any one of sectional views of the optical structure. A length of the curve corresponding to the shape of the recessed structure 21 in any one of sectional views of the optical structure is the same as a length of the curve corresponding to the shape of the protruding structure 11 in any one of sectional views of the optical structure. An orthographic projection of a center b1 of an arc curved surface of the recessed structure 21 on a plane parallel to a base substrate of a display panel (e.g., plane a) overlaps with an orthographic projection of a center b2 of an arc curved surface of the protruding structure 11 on the plane. An orthographic projection of the recessed structure 21 on the plane a overlaps with an orthographic projection of the protruding structure 11 on the plane a.

In some embodiments, as shown in FIG. 2B, a shape of the protruding structure is a strip, and a protruding surface of the protruding structure is an arc curved surface. In some embodiments, the plurality of protruding structures is parallel to an array substrate in columns or rows.

In some embodiments, the plurality of protruding structures is in a one-to-one correspondence with pixel units on the array substrate, and each of the plurality of protruding structures has a plurality of intersecting cross sections in a direction perpendicular to the array substrate, each cross section has a rounded side away from the array substrate.

With the above optical structure, the recessed structure 21 is disposed opposite to the protruding structure 11 in one-to-one correspondence, a shape of each recessed structure 21 matches with a shape of a corresponding protruding structure 11, and a size of each recessed structure 21 matches with a size of a corresponding protruding structure 11.

In the optical structure, the liquid crystal layer 30 has a same thickness at different positions of the optical structure.

The recessed structure 21 and the protruding structure 11 are not limited to the structure having arc curved surfaces. Based on above-described arrangement principle, as long as the recessed structure 21 and the protruding structure 11 are oppositely disposed in one-to-one correspondence, and the shape and the size of the recessed structure 21 match with the shape and size of the corresponding protruding structure 11 respectively, the CR of the optical structure can be increased.

In some embodiments, as shown in FIG. 2A, the plurality of protruding structures 11 is sequentially connected on the surface of the first positioning plate 11 close to the liquid crystal layer 30; and based on an arrangement of the plurality of protruding structures 11 being arranged in a one-to-one correspondence with the plurality of recessed structures 21, the plurality of recessed structures 21 is sequentially connected on the surface of the second positioning plate 20 close to the liquid crystal layer 30.

In some embodiments, the optical structure is applied to the display panel, the protruding structure 11 and the recessed structure 21 which are disposed in a one-to-one correspondence, are disposed corresponding to one pixel unit on an array substrate and an color film layer of the display panel.

In some embodiments, the first positioning plate 10 and the second positioning plate 20 are made of a transparent material. For example, the transparent material is made of a transparent resin (e.g., a polystyrene (PS) resin or an organic film resin).

In some embodiments, the optical structure described above is applied to the display panel, and the liquid crystal layer 30 between the first positioning plate 10 and the second positioning plate 20 forms a liquid crystal layer of the display panel.

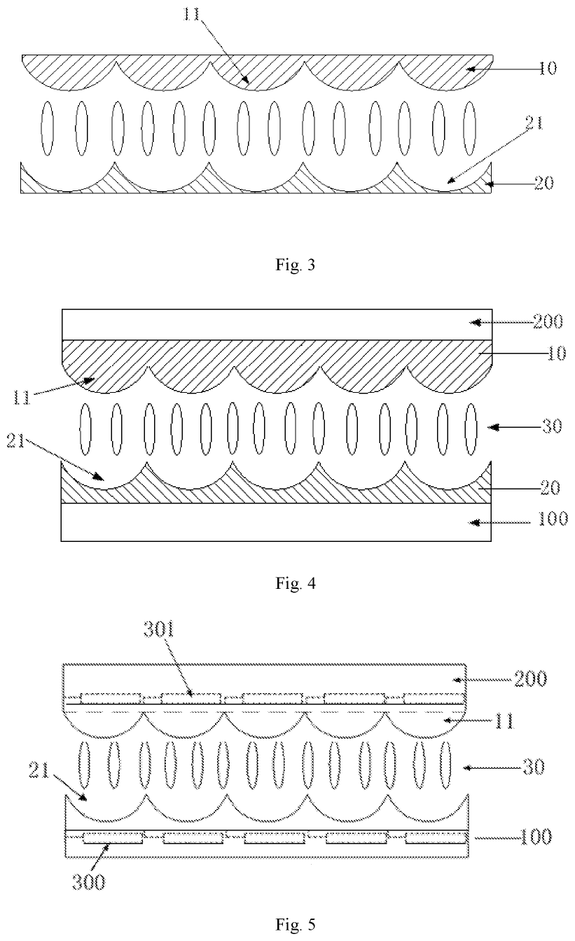

In some embodiments, as shown in FIG. 3, for lighting and thinning of the display panel, a thickness of the first positioning plate 10 is slightly greater than a maximum thickness of a protruding portion of the protruding structure 11, and a thickness of the second positioning plate 20 is slightly greater than a maximum depth of a recessed portion of a recessed structure 21, that is, a height requirement of the protruding structure 11 on the first positioning plate 10 and a depth requirement of the recessed structure 21 on the second positioning plate 20 shall be met.

In some embodiments, one of the first positioning plate 10 and the second positioning plate 20 is disposed on an array substrate of a display panel, and the other is disposed on an opposite substrate opposite to the array substrate.

One of the protruding structure 11 and the recessed structure 21 having the above-mentioned structures is formed on the array substrate, and the other of the protruding structure 11 and the recessed structure 21 is formed on a substrate opposite to the array substrate. The two substrates are oppositely arranged to form a cell, and a space between the two substrates is filled with liquid crystal to form a liquid crystal layer shown in FIG. 2A. Compared with display panels in the related art, the thickness of the liquid crystal layer is reduced and CR is increased, thereby solving the problem of a lowered CR for large viewing angle which cannot meet the user's visual requirement.

Some embodiments provide a display device including the above optical structure shown in FIG. 1 and FIG. 2A.

The optical structure arranged in the display panel may refer to FIG. 1, FIG. 2A and the detailed description above, and the details thereof are omitted herein.

In some embodiments, in combination with the optical structure shown in FIG. 2A and FIG. 4, the display panel includes an array substrate 100 and an opposite substrate 200 which are disposed opposite to each other, and the optical structure in FIG. 2A is disposed between the array substrate 100 and the opposite substrate 200. In some embodiments, when the array substrate 100 is separated from the color filter layer, the opposite substrate 200 is a color filter substrate.

In the embodiments of the above display panel, the first positioning plate 10 and the second positioning plate 20 are formed independently from structures of the array substrate 100 and the opposite substrate 200. Through forming the first positioning plate 10 and the second positioning plate 20 shown in FIG. 1 or FIG. 2A, in a process of assembling the display device, the first positioning plate 10 and the second positioning plate 20 are oppositely arranged to form a cell, a space between the first positioning plate 10 and the second positioning plate 20 forms a liquid crystal filling layer, and the liquid crystal filling layer is filled with liquid crystal to form the liquid crystal layer 30.

In above embodiments, by forming the liquid crystal layer 30 through oppositely arranging the first positioning plate 10 and the second positioning plate 20 to form a cell, the optical structure is formed in the above embodiment. Compared with the display device in the related art, the optical structure is integrally disposed between the array substrate 100 and the color filter substrate when the optical structure is applied to the display device, which reduces the thickness of the liquid crystal layer and increases the CR. Therefore, the problem that the CR is low at a large viewing angle and the user's visual requirements cannot be satisfied is solved.

In some embodiments, in conjunction with FIG. 5, taking an optical structure including both the plurality of protruding structures and the plurality of recessed structures as an example, the display device includes an array substrate 100 and an opposite substrate 200 which are disposed opposite to each other. In some embodiments, the first positioning plate 10 is disposed on the array substrate 100, and the second positioning plate 20 is disposed on the opposite substrate 200. That is, the plurality of protruding structures 11 is formed on the array substrate 100, and the plurality of recessed structures 21 is disposed on the opposite substrate 200. In some embodiments, the first positioning plate 10 is disposed on the opposite substrate 200, and the second positioning plate 20 is disposed on the array substrate 100. That is, the plurality of protruding structures 11 is formed on the opposite substrate 200, and the plurality of recessed structures 21 is disposed on the array substrate 100. In some embodiments, the array substrate 100 is separated from the color filter layer, and the opposite substrate 200 is a color filter substrate.

In FIG. 5, taking forming the plurality of protruding structures 11 on the color filter substrate and the plurality of recessed structures 21 on the array substrate 100 as an example, structures of display panel in some embodiments are described.

In the display panel of FIG. 5, by forming the plurality of protruding structures 11 on the color filter substrate and forming the plurality of recessed structures 21 on the array substrate 100, a space between the color filter substrate and the array substrate forms a space for filling the liquid crystal. Since the plurality of protruding structures 11 and the plurality of recessed structures 21 are disposed in the space, after filling the space with the liquid crystal layer 30, a surface of the liquid crystal layer 30 is formed along with the protruding structure 11 and the recessed structure 21. For example, if the plurality of recessed structures is formed on the array substrate, recessed portions of the plurality of recessed structures are filled with liquid crystal of the liquid crystal layer 30. Compared with a structure in which two opposite surfaces for forming the liquid crystal layer 30 are planes in the related art, when the lateral viewing angle is 0, the thickness of a path through which an incident light penetrates the liquid crystal layer in the optical structure is reduced. Since the thickness of the liquid crystal layer is inversely proportional to the CR, CR is increased. Compared with display devices in the related art, a display device including the optical structure described above has an increased CR, thereby solving the problem that the CR is low at a large viewing angle and the visual requirements of the user cannot be satisfied.

In some embodiments, the plurality of protruding structures 11 is formed on the color filter substrate, and the plurality of recessed structures 21 is directly formed on the array substrate 100 to meet lighting and thinning requirements of the display device.

In some embodiments, as shown in FIG. 5, the array substrate 100 in the display device is provided with a first pixel structure 300 of a pixel unit, the opposite substrate 200 is a color film substrate provided with a second pixel structure 301 of the pixel unit. As shown in FIG. 5, a projection of the first pixel structure 300 on the array substrate 100 is located in an orthographic projection of a corresponding protruding structure 11 on a plane of the array substrate 100, and a projection of one first pixel structure 300 on the plane of the array substrate 100 is located in an orthographic projection of one protruding structure 11 on the plane of the array substrate 100. As shown in FIG. 5, a projection of the second pixel structure 301 on the color filter substrate 200 is located in an orthographic projection of a corresponding protruding structure 11 on a plane of the color filter substrate 200, and a projection of one second pixel structure 301 on the plane of the color filter substrate 200 is located in an orthographic projection of one protruding structure 11 on the plane of the color filter substrate 200.

The plurality of protrusion structures 11 shown in FIG. 2A is disposed in a one-to-one correspondence with the plurality of recess structures 21. Similarly, the projection of the first pixel structure 300 and/or the second pixel structure 301 on the plane of the array substrate 100 (or the plane of the opposite substrate 200) is located in the orthographic projection of recessed structures 21 on the plane of the array substrate 100 (or the plane of the opposite substrate 200). An orthographic projection of one pixel unit (including a first pixel structure 300 and a second pixel structure 301) on the plane of the array substrate 100 (or the opposite substrate 200) is located in an orthographic projection of the protrusion structure 11 as well as the opposite recessed structure 21 on the plane of the array substrate 100 (or the opposite substrate 200).

In some embodiments, the number of pixel units is the same as the number of the plurality of protruding structures 11, and orthographic projections of different pixel units on the plane of the array substrate 100 is located in an orthographic projection of different protruding structures 11 on the plane of the array substrate 100. The first pixel structure 300 includes a thin film transistor, and the second pixel structure 301 includes a color resistance layer.

In some embodiments, the display device of the embodiments shown in FIG. 4 includes a pixel unit, a relatively position of the protruding structure 11 and the pixel unit can be the same as a relatively position of the protruding structure 11 and the pixel unit (including the first pixel structure 300 and the second pixel structure 301) of a display device shown in FIG. 5, and a relatively position of the recessed structure 21 and the pixel unit can be the same as a relatively position of the recessed structure 21 and the pixel unit (including the first pixel structure 300 and the second pixel structure 301) of a display device shown in FIG. 5.

With the optical structure in the above embodiments, the liquid crystal layer 30 has a uniform light transmission effect for each pixel unit, achieving a better display effect.

In some embodiments, the display device is a product or component with a display function, such as a liquid crystal panel, a mobile phone, a computer, or a Portable Device (PAD).

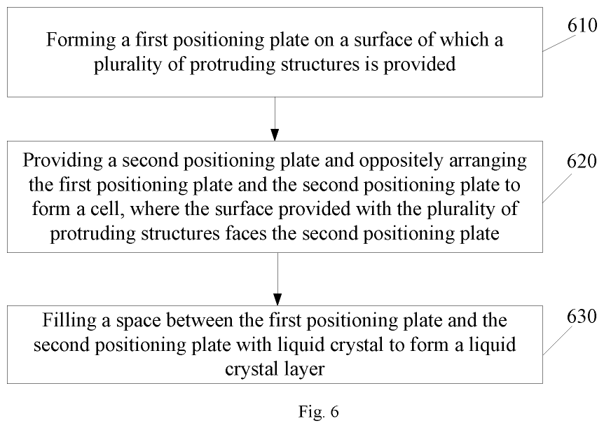

Some embodiments provide a method for manufacturing an optical structure. As shown in FIG. 6, the method includes steps 610, 620, and 630.

In the step 610, a first positioning plate on a surface of which a plurality of protruding structures is provided is formed.

In the step 620, a second positioning plate is provided, and the first positioning plate and the second positioning plate are oppositely arranged to form a cell, where the surface provided with the plurality of protruding structures faces the second positioning plate.

In the step 630, a space between the first positioning plate and the second positioning plate is filled with liquid crystal to form a liquid crystal layer.

The structure of the optical structure manufactured through the method above is shown in FIGS. 1 to 3.

In some embodiments, the step 620 includes forming the second positioning plate on a surface of which a plurality of recessed structures is provided, and in the step of oppositely arranging the first positioning plate and the second positioning plate to form a cell, a surface of the second positioning plate formed with a plurality of recessed structures faces the first positioning plate.

In some embodiments, the step of forming a first positioning plate on a surface of which a plurality of recessed structures is provided in step 610 includes:

providing a color film substrate; coating a transparent material layer on the color film substrate; and forming the plurality of protruding structures on the transparent material layer through a patterning process to form the first positioning plate; or,

providing an array substrate; coating a transparent material layer on the array substrate; and forming the plurality of protruding structures on the transparent material layer through a patterning process to form the first positioning plate.

In some embodiments, the step of forming the second positioning plate on a surface of which a plurality of recessed structures is provided in step 620 includes:

providing a color film substrate; coating a transparent material layer on the color film substrate; and forming the plurality of recessed structures on the transparent material layer through a patterning process to form the second positioning plate; or,

providing an array substrate; coating a transparent material layer on the array substrate; and forming the plurality of recessed structures on the transparent material layer through a patterning process to form the second positioning plate.

In some embodiments, in the above step 610, the color film substrate is provided, a transparent material layer is coated on the color film substrate, and the plurality of protruding structures is formed through a patterning process to form the first positioning plate; and in step 620, the array substrate is provided, a transparent material layer is coated on the array substrate, and the plurality of recessed structures is formed through a patterning process to form the second positioning plate.

In some embodiments, the transparent material layer is a transparent resin (e.g., a polystyrene (PS) resin or an organic film resin).

In some embodiments, the patterning process used to manufacture the plurality of protruding structures and the plurality of recessed structures includes processes such as developing and exposing. In some embodiments, the transparent material layer is exposed through a semi-transparent mask during the exposing process.

The optical structure manufactured through the methods of the above embodiment provides a liquid crystal layer with reduced thickness and an increased CR, as compared with the display device of the related art, thereby solving the problem of a lowered CR for large viewing angle which cannot meet the user's visual requirements.

The above is a description of some embodiments of the present disclosure. A person skilled in the art may make further modifications and improvements without departing from principles of the present disclosure, and these modifications and improvements shall also fall within the scope of the present disclosure.

1. An optical structure, comprising a first positioning plate, a second positioning plate and a liquid crystal layer;
wherein the first positioning plate and the second positioning plate are oppositely disposed;
the liquid crystal layer is arranged between the first positioning plate and the second positioning plate; and
a surface of the first positioning plate close to the liquid crystal layer is provided with a plurality of protruding structures protruding toward the liquid crystal layer.

2. The optical structure according to claim 1, wherein a surface of the second positioning plate close to the liquid crystal layer is provided with a plurality of recessed structures recessed away from the liquid crystal layer.

3. The optical structure according to claim 1, wherein the liquid crystal layer has an identical thickness at any position between the first positioning plate and the second positioning plate.

4. The optical structure according to claim 2, wherein the number of the plurality of recessed structures is the same as the number of the plurality of protruding structures, and each recessed structure is arranged oppositely to one of the plurality of protruding structure, a shape of the recessed structure matches with a shape of the protruding structure, and a size of the recessed structure matches with a size of the protruding structure.

5. The optical structure according to claim 2, wherein the plurality of recessed structures and the plurality of protruding structures have arc curved surfaces.

6. The optical structure according to claim 1, wherein the plurality of protruding structures is sequentially connected on the surface of the first positioning plate close to the liquid crystal layer.

7. The optical structure according to claim 1, wherein the first positioning plate and the second positioning plate are made of a transparent material.

8. A display device comprising the optical structure according to claim 1.

9. The display device according to claim 8, further comprising:
an array substrate; and
an opposite substrate;
wherein the optical structure is disposed between the array substrate and the opposite substrate.

10. The display device according to claim 9, wherein the array substrate comprises a plurality of pixel units;
an orthogonal projection of each of the plurality of pixel units on the array substrate is located in an orthogonal projection of one of the plurality of protruding structures corresponding to the pixel unit on a plane of the array substrate;
the number of the plurality of pixel units on the array substrate is the same as the number of the plurality of protruding structures; and
different pixel units of the plurality of pixel units are located in different orthogonal projections of different protruding structures of the plurality of protruding structures on the plane of the array substrate.

11. The display device according to claim 9, wherein the first positioning plate is disposed on the array substrate, and the second positioning plate is disposed the opposite substrate; or
the first positioning plate is disposed on the opposite substrate, and the second positioning plate is disposed the array substrate.

12. A method for manufacturing an optical structure, comprising:
forming a first positioning plate on a surface of which a plurality of protruding structures is provided;
providing a second positioning plate and oppositely arranging the first positioning plate and the second positioning plate to form a cell, wherein the surface of the first positioning plate provided with the plurality of protruding structures faces the second positioning plate; and
filling a space between the first positioning plate and the second positioning plate with liquid crystal to form a liquid crystal layer.

13. The method according to claim 12, wherein the providing the second positioning plate comprises forming the second positioning plate on a surface of which a plurality of recessed structures is provided; and
the surface of the second positioning plate provided with the plurality of recessed structures faces the first positioning plate.

14. The method according to claim 12, wherein the forming the first positioning plate on a surface of which a plurality of protruding structures is provided comprises:
providing a color film substrate; coating a transparent material layer on the color film substrate; and forming the plurality of protruding structures on the transparent material layer through a patterning process to form the first positioning plate; or,
providing an array substrate; coating a transparent material layer on the array substrate; and forming the plurality of protruding structures on the transparent material layer through a patterning process to form the first positioning plate.

15. The method according to claim 13, wherein the forming the second positioning plate on a surface of which a plurality of recessed structures is provided comprises:
providing a color film substrate; coating a transparent material layer on the color film substrate; and forming the plurality of recessed structures on the transparent material layer through a patterning process to form the second positioning plate; or,
providing an array substrate; coating a transparent material layer on the array substrate; and forming the plurality of recessed structures on the transparent material layer through a patterning process to form the second positioning plate.
